(19) United States
(12) Patent Application Publication
(10) Pub. No.: US 2020/0164835 A1
(43) Pub. Date: May 28, 2020

(54) VEHICLE CONTROL APPARATUS USING A SMART KEY PROVIDED WITH A DISPLAY AND A METHOD OF CONTROLLING THE SAME

(71) Applicants: HYUNDAI MOTOR COMPANY, Seoul (KR); KIA MOTORS CORPORATION, Seoul (KR)

(72) Inventors: Jae Hoon Chung, Hwaseong-si (KR); Sung Un Kim, Yongin-si (KR); Si Hoon Sung, Hwaseong-si (KR)

(73) Assignees: HYUNDAI MOTOR COMPANY, Seoul (KR); KIA MOTORS CORPORATION, Seoul (KR)

(21) Appl. No.: 16/688,395

(22) Filed: Nov. 19, 2019

(30) Foreign Application Priority Data
Nov. 22, 2018 (KR) 10-2018-0145593

(51) Int. Cl. B60R 25/34; B60R 25/24; B60R 25/25; G07C 9/00

(52) U.S. Cl. CPC B60R 25/34; B60R 25/24; B60R 25/252; G07C 2009/00507; G07C 9/00563; G07C 9/00944; B60R 2325/101; G07C 9/00309

(57) ABSTRACT

A vehicle control apparatus and method use a smart key provided with a display. The vehicle control method includes: an integrated manipulation unit detecting attachment of the smart key through a smart key detector disposed in a predetermined attachment area inside a vehicle; the integrated manipulation unit transmitting information on a target control function corresponding to a vehicle state to the smart key; outputting a first user interface corresponding to the information on the target control function on a first display of the smart key; transmitting information on a result of manipulation from the smart key to the integrated manipulation unit when an operating portion provided in the smart key is operated; and the integrated manipulation unit controlling the target control function based on the information on the result.

This application claims priority to and the benefit of Korean Patent Application No. 10-2018-0145593, filed on Nov. 22, 2018, which is hereby incorporated by reference as if fully set forth herein.

### BACKGROUND

### Field of the Disclosure

The present disclosure relates to a user interface capable of controlling various functions in a vehicle. More particularly, the present disclosure relates to a vehicle control apparatus using a smart key provided with a display and a method of controlling the same.

### Discussion of the Related Art

A smart key is an electronic access and authorization device used in newer cars that is wirelessly recognized within a certain distance outside a vehicle or inside the vehicle. Instead, older cars require putting or inserting a key into the vehicle.

The smart key generally includes a key card having a flat shape and a key fob having a polygonal/elliptical flat shape. The smart key has a plurality of key buttons on an upper surface thereof. One key button is mapped to one function. As the number of functions allowing control through the smart key increases, the number of key buttons increases. For example, recently, the configuration of the key buttons of the smart key has been complicated by applying new technology such as remote automatic parking. Demand for remotely calling and controlling the vehicle will further increase in the future.

The smart key is widely used to control various functions through the key buttons outside the vehicle. However, the smart key is only used to allow the activation of the ignition of the vehicle through detection or to release an immobilizer inside the vehicle.

### SUMMARY

Accordingly, the present disclosure is directed to a vehicle control apparatus using a smart key provided with a display and a method of controlling the same that substantially obviate one or more problems due to limitations and disadvantages of the related art.

An object of the present disclosure is to provide a more convenient vehicle manipulation system and a method of controlling the same.

Another object of the present disclosure is to provide a vehicle apparatus capable of controlling various vehicle functions using a smart key provided with a display and a method of controlling the same.

Additional advantages, objects, and features of the disclosure are set forth in part in the description which follows and in part should become apparent to those having ordinary skill in the art upon examination of the following or may be learned from practice of the disclosed embodiments. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a vehicle control method using a smart key includes an integrated manipulation unit detecting attachment of the smart key through a smart key detector disposed in a predetermined attachment area inside a vehicle. The method further includes the integrated manipulation unit transmitting information on a target control function corresponding to a vehicle state to the smart key. The method also includes outputting a first user interface corresponding to the information on the target control function on a first display of the smart key. The method further includes transmitting information on a result of manipulation from the smart key to the integrated manipulation unit when an operating portion provided in the smart key is operated. The method also includes the integrated manipulation unit controlling the target control function based on the information on the result.

In another aspect of the present disclosure, a vehicle manipulation system includes a smart key including an operating portion and a first display. The system further includes an integrated manipulation unit configured to transmit information on a target control function corresponding to a vehicle state to the smart key when the integrated manipulation unit detects attachment of the smart key through a smart key detector disposed in a predetermined attachment area inside a vehicle. The smart key outputs a first user interface corresponding to the information on the target control function on the first display. The smart key further transmits information on a result of manipulation to the integrated manipulation unit when the operating portion is operated. The integrated manipulation unit controls the target control function based on the information on the result.

It is to be understood that both the foregoing general description and the following detailed description of the present disclosure are by way of example and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure. Together with the description, the drawings serve to explain the principle of the disclosure. In the drawings:

FIG. 1 is a view showing an example of the structure of a vehicle manipulation system including a smart key according to an embodiment of the present disclosure;

FIG. 2 is a view illustrating the appearance of a smart key according to an embodiment of the present disclosure;

FIG. 3 is a view showing an example of an operating form of a manipulation system according to an embodiment of the present disclosure;

FIG. 4 is a flowchart illustrating an example of a process of operating a vehicle display system including a smart key according to an embodiment of the present disclosure;

FIG. 5 is a view showing an example of attaching a smart key according to an embodiment of the present disclosure to a vehicle;

FIG. 6 is a view showing an example of the arrangement of a fixing unit for fixing a smart key according to an embodiment of the present disclosure;

FIG. 7 is a view showing an example of performing welcome and start functions using a smart key according to an embodiment of the present disclosure;

FIG. 8 is a view showing attachment areas according to an embodiment of the present disclosure;

FIG. 9 is a view showing the form of a user interface configured along with a display of an integrated controller when a smart key according to an embodiment of the present disclosure is attached to an attachment area of a vehicle; and

FIG. 10 is a view showing an example of the function of a smart key according to an embodiment of the present disclosure.

### DETAILED DESCRIPTION OF THE DISCLOSURE

Hereinafter, embodiments of the present disclosure are described in detail with reference to the accompanying drawings so as to be implemented by those having ordinary skill in the art. However, the present disclosure may be variously implemented and is not limited to the embodiments described herein. In the drawings, in order to clearly describe the present disclosure, portions which are not related to the description of the present disclosure have been omitted. Similar portions are denoted by similar reference numerals throughout the specification.

In the entire specification, when a certain portion “includes” a certain component, this indicates that the other components are not excluded, but may be further included unless specially described. The same reference numbers are used throughout the drawings to refer to the same or like parts.

In the embodiments of the present disclosure, when a smart key provided with a display is attached to a predetermined point inside a vehicle, it is possible to control various vehicle functions.

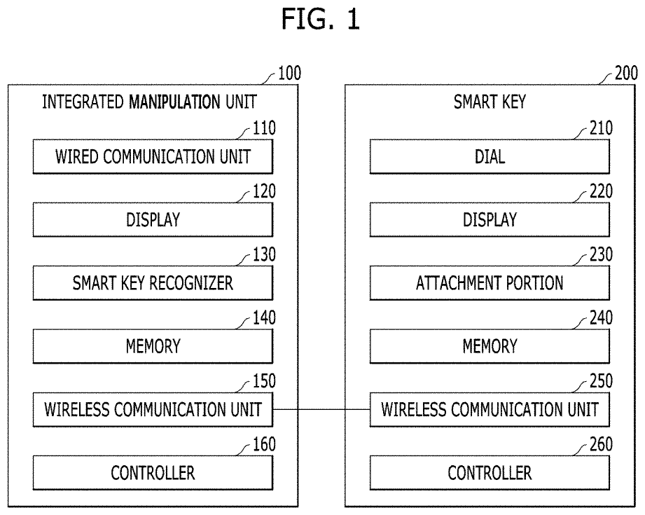

The structure of a vehicle manipulation system, including a smart key applicable to the embodiments of the present disclosure, is described below with reference to FIG. 1. FIG. 1 is a view showing an example of the structure of a vehicle manipulation system including a smart key according to an embodiment of the present disclosure.

Referring to FIG. 1, the vehicle manipulation system according to an embodiment may include an integrated manipulation unit 100 and a smart key 200.

The integrated manipulation unit 100 may include a wired communication unit 110, a display 120, a smart key recognizer 130, a memory 140, a wireless communication unit 150 and a controller 160. Hereinafter, these components are described in detail.

The wired communication unit 110 may exchange data with a controller for controlling at least a plurality of functions inside the vehicle. For example, the wired communication unit 110 may support at least one of vehicle communication methods such as CAN, CAN-FD, LIN, Ethernet, and the like. In another example, the wired communication unit 110 may receive operation state information from an air conditioner for controlling an air conditioning function, a body controller for performing a convenience function such as a seat, and an audio/video/navigation (AVN) system. The wired communication unit 110 may also transmit a control command.

The display 120 serves to visually output a vehicle operation state such as a navigation guidance screen, operation state information of an air conditioner system, playback state information of a multimedia function or a variety of information necessary for a driver. The display 120 may further display a virtual manipulation system for controlling at least some functions and may detect a touch command input to the virtual manipulation system when the display is a touchscreen.

The smart key recognizer 130 may detect whether the smart key 200 is detached. For example, the smart key recognizer 130 may include at least one of a Hall sensor for detecting a magnetic force, a near-field communication (NFC) transceiver for performing NFC communication, or a wireless charging transmitter for detecting a wireless charging receiver. In other words, the smart key 200 may be detected by the Hall sensor when a permanent magnet is provided in the smart key 200. The smart key 200 may be detected by the NFC transceiver when an NFC tag is provided in the smart key 200. The smart key 200 may be detected by the wireless charging transmitter when the wireless charging receiver is provided in the smart key 200. The detection of the smart key 200 mentioned above is an example and is not limited thereto. In addition, the smart key recognizer 130 detects whether the smart key 100 is attached to the integrated manipulation unit 100 at a specific position separately from a smart key controller to determine whether the smart key is present inside the vehicle.

The memory 140 may store an operating system for driving the integrated manipulation unit 100, various application programs operating on the operating system, multimedia content, input/output control information, and the like.

The wireless communication unit 150 may be connected to at least a wireless communication unit 250 of the smart key 200 using a short-range communication protocol (e.g., Bluetooth, Wi-Fi, ZigBee, NFC, and the like) or a 3/4/5G protocol to perform data exchange.

The controller 160 performs overall control of the above-described components and may perform determination and operation necessary to control target control functions through interfacing with the smart key 200 according to the below-described embodiments of the present disclosure.

The smart key 200 may include a dial 210 (or a wheel), a display 220, an attachment portion 230, a memory 240, a wireless communication unit 250 and a controller 260.

The memory 240 may store an operating system for driving the smart key 200, identification information of each target control function, a graphical user interface to be output on a display for each target control function, input/output control information of the smart key 200, and the like.

The wireless communication unit 250 may be connected to at least a wireless communication unit 150 of the integrated manipulation unit 100 using a short-range communication protocol (e.g., Bluetooth, Wi-Fi, ZigBee, NFC, and the like.) or a 3/4/5G protocol to perform data exchange. In some embodiments, the wireless communication unit 250 may be configured to perform communication with a telematics server or another smart device (e.g., a smartphone, a tablet, and the like). In addition, the wireless communication unit 250 may include an ultra-high frequency/low frequency (UHF/LF) communication module for performing wireless communication with a smart key controller SMK of the vehicle in order to perform the general functions of the smart key.

The controller 260 performs overall control of the other components and may perform determination and operation necessary to control functions through interfacing with the integrated manipulation unit 100 according to the below-described embodiments of the present disclosure.

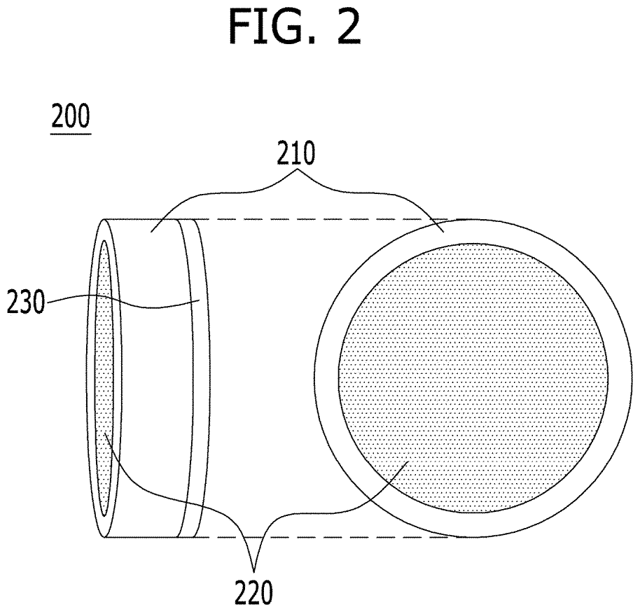

The dial 210, the display 220 and the attachment portion 230 are described below with reference to FIG. 2. FIG. 2 is a view illustrating the appearance of a smart key according to an embodiment of the present disclosure.

Referring to FIG. 2, the smart key 200 according to the embodiment may have a cylindrical appearance. Specifically, the smart key 200 may have a toroidal or ring-shaped dial 210 surrounding a circular display 220. The rear surface opposite to the front surface of the display 220 may have an attachment portion 230 including a contact surface attached to the display 120 of the integrated manipulation unit 100.

The dial 210 may be configured to rotate along the circumferential surface of the dial 210 about the display 220 and to detect at least a direction and degree of rotation (e.g., displacement or angle) when a user rotates the dial. The present disclosure is not limited to a specific unit or method for detecting rotation.

The display 220 may have a circular appearance. An actual display area need not necessarily correspond to an outer area defined by the inner diameter of the dial 210 and need not necessarily have a circular shape. In addition, the display 220 may be implemented in the form of a touchscreen. The display 220 may be configured to receive a touch command input to the display 220. The display 220 may be configured to include a push button function. In addition, a detection member formed of a piezoelectric material may be disposed on the lower surface of the display 220 in a predetermined array form. Electrodes are connected such that a fingerprint sensor is provided.

As described above, the attachment portion 230 may include a portion to be recognized (e.g., a magnet, an NFC tag, a wireless charging receiver, and the like) corresponding to the smart key recognizer 130. A permanent magnet may be disposed in a predetermined area for attachment of the smart key 200 by magnetic force to a magnetic material (e.g., a permanent magnet or an electromagnet) disposed in the peripheral area of the display 120 or the rear surface of the display 120 of the integrated manipulation unit 100. The magnitude of the magnetic force may be greater than a rotation resistance of the dial 210, while detachment does not occur by vibration generally occurring while the vehicle is traveling when the smart key 200 is attached to a predetermined area. This is to prevent a phenomenon where the smart key 200 itself rotates (e.g., the display 220 also rotates) without moving the dial 210 from the viewpoint of the smart key 200 in the case where magnetic force is less than rotation resistance when the user rotates the dial 210.

It should be apparent to those having ordinary skill in the art that the magnitude of the magnetic force may vary according to the weight of the smart key 200, an angle between the position where the smart key 200 is attached inside the vehicle and the ground, and the rotation resistance of the dial 210.

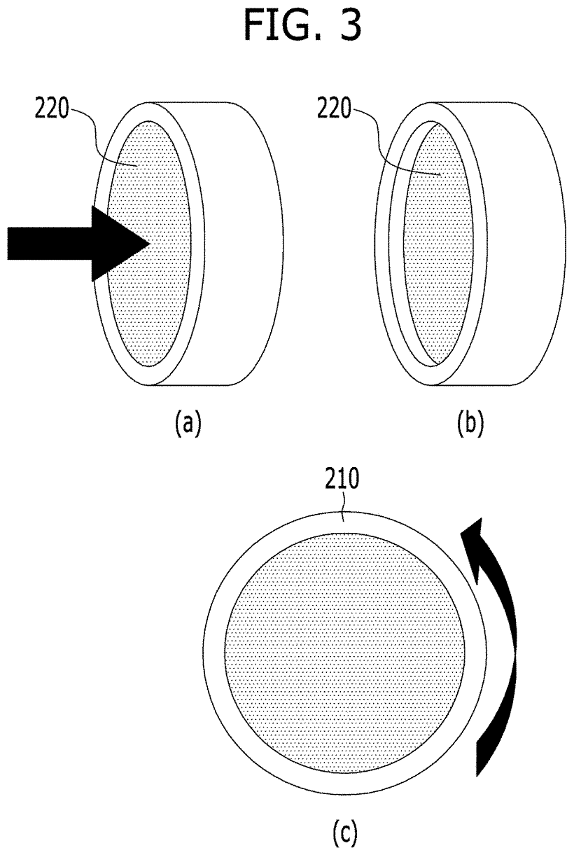

The manipulation method of a manipulation system according to an embodiment is described with reference to FIG. 3. FIG. 3 is a view showing an example of a manipulation form of a manipulation system according to an embodiment of the present disclosure.

When the smart key 200 has a push button, the front surface of the dial 210 or the display 220 may be pressed. For example, when the display 220 is pressed as shown in (a) of FIG. 3, the display 220 may be retracted by a certain distance in the pressed direction as shown in (b) of FIG. 3. In the case where the display 220 is implemented as a touchscreen, only a touch input may be recognized when the touchscreen is touched at a predetermined pressure or less. For example, a touch command may include a simple touch, a long touch, a double touch that includes inputting the simple touch twice for a predetermined time, and a touch-drag/flicking touch input of dragging in a touched state in an arbitrary direction, and then releasing the touch. The touch commands may correspond to different types of control commands, respectively.

Alternatively, as shown in (c) of FIG. 3, the smart key 200 may be operated to rotate the dial 210 clockwise or counterclockwise.

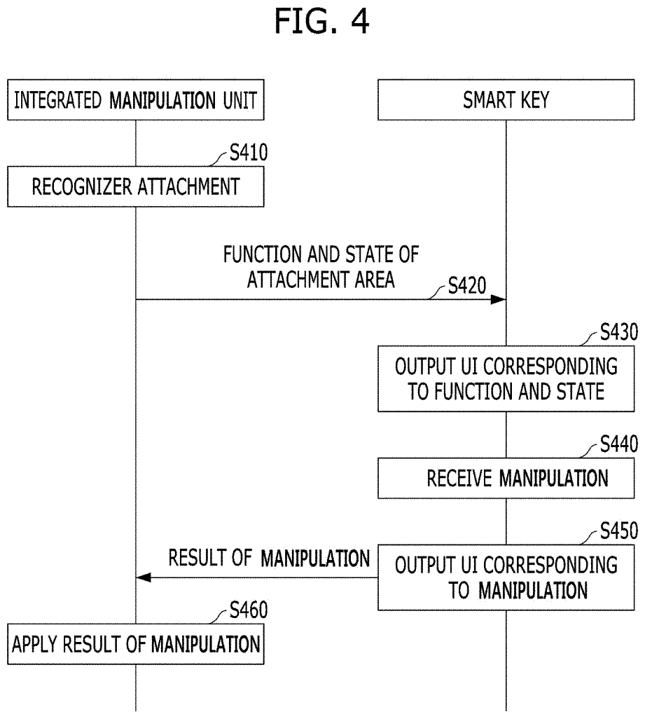

Hereinafter, a process of performing the function for linking the smart key and the integrated manipulation unit based on the configuration of the apparatus is described with reference to FIG. 4.

FIG. 4 is a flowchart illustrating an example of a process of operating a vehicle display system including a smart key according to an embodiment of the present disclosure.

Referring to FIG. 4, as the smart key 200 is attached at a predetermined position, the integrated manipulation unit 100 may detect whether the smart key 200 is attached (or may detect an attachment position of the smart key 200) through the smart key recognizer 130 (S410).

The integrated manipulation unit 100 may transmit information on the target control function according to the current vehicle state to the smart key 200 through the wireless communication unit 150 (S420). In this example, the information on the target control function may include the type of the target control function and the current state information of the function. In one example, the target control function according to the state of the vehicle may be a start button function before starting the vehicle after the driver enters the vehicle. In another example, the control function may be a function for welcoming the owner of the vehicle. The examples recited above are merely examples, and the control function is not limited thereto.

The smart key 200 may output a graphical user interface (UI) corresponding to the target control function and the current state on the display 220 based on the received information (S430).

Thereafter, when the dial 210 is operated or when a user input such as a touch input or a push input is received on the display 220 (S440), the smart key 200 may output a user interface corresponding to the manipulation (i.e., a change in state information output through the user interface) on the display 220 (S450). Information on the manipulation (e.g., a manipulation amount, a control amount, a manipulation direction, the type of a changed function, and the like) may be transmitted to the integrated manipulation unit 100 through the wireless communication unit 250.

The integrated manipulation unit 100 may apply the result of manipulation to the target control function based on the information on the manipulation (S460).

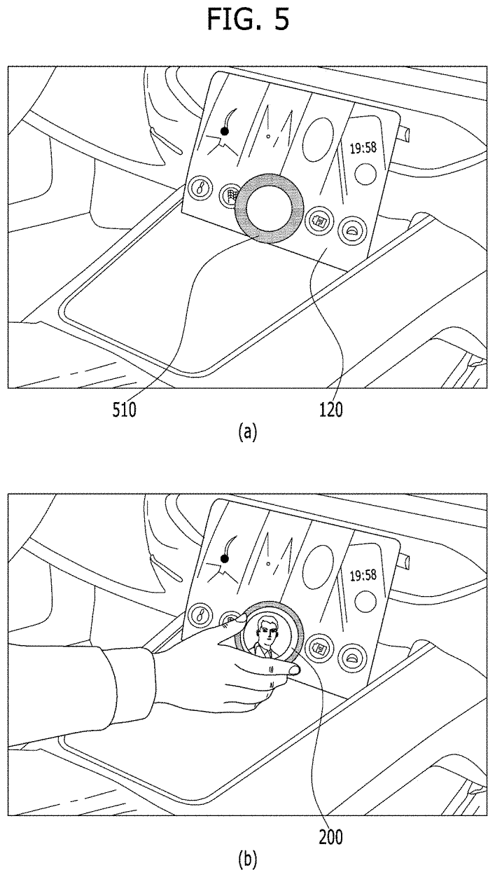

A detailed example of attaching a smart key is described with reference to FIG. 5. FIG. 5 is a view showing an example of attaching a smart key according to an embodiment of the present disclosure to a vehicle.

Referring to (a) of FIG. 5, the display 120 of the integrated manipulation unit 100 is provided at the lower end of a center fascia. The smart key 200 is ready to be attached to the lower central area 510 of the display 120. In this state, when the smart key 200 is attached to the lower central area 510 of the display 120 as shown in (b) of FIG. 5, the image of a driver corresponding to the welcome function may be displayed on the display of the smart key 200. At this time, in order to perform a personalization function including the welcome function, when the smart key 200 is attached to a predetermined attachment area such as the lower central area 510, the smart key 200 may transmit authentication information capable of identifying the driver to the integrated manipulation unit 100. Examples of the personalization function may include loading and applying a seat position set by the driver, air conditioning setting, multimedia setting (equalizer, play list or radio channel settings), and drive mode setting, in addition to the welcome function.

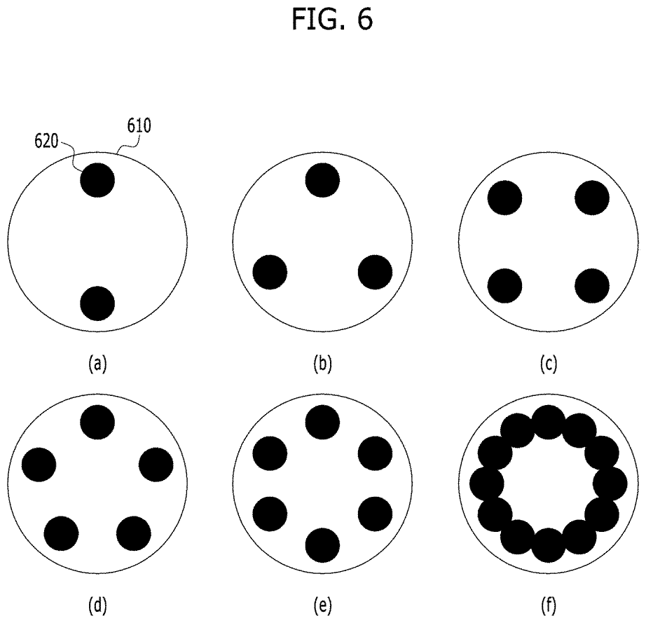

The area 510, to which the smart key 200 is attached, needs to include a permanent magnet or an electromagnet as a portion for fixing the smart key by magnetic force, along with the smart key detector 130, as described above. The fixing portion is described with reference to FIG. 6. FIG. 6 is a view showing an example of the arrangement of a fixing unit for fixing a smart key according to an embodiment of the present disclosure.

In (a)-(f) of FIG. 6, a large circle 620 corresponds to the plane shape of the smart key 200 and indicates the attachment position of the smart key 200. Small circles 620 indicate positions where permanent magnets or electromagnets are disposed. For example, all the small circles 620 may be permanent magnets or electromagnets. Alternatively, some of the small circles may be permanent magnets and the other small circles may be electromagnets.

Two or more electromagnets or permanent magnets may be provided such that the smart key 200 itself does not rotate by manipulation of the dial 210 after the smart key 200 is attached. In addition, the electromagnets or permanent magnets may be symmetrically disposed with respect to the center of the attachment position 610. The smart key is easily attached at an accurate position, only by disposing the smart key 200 to be close to the attachment position. The position and number of electromagnets or permanent magnets within the attachment position 610 may be equally applied to the attachment portion 230 of the smart key 200.

In addition, when the electromagnets are used, the electromagnets may be configured to generate magnetic force only when the smart key 200 is detected by the smart key detector 130, in order to save power.

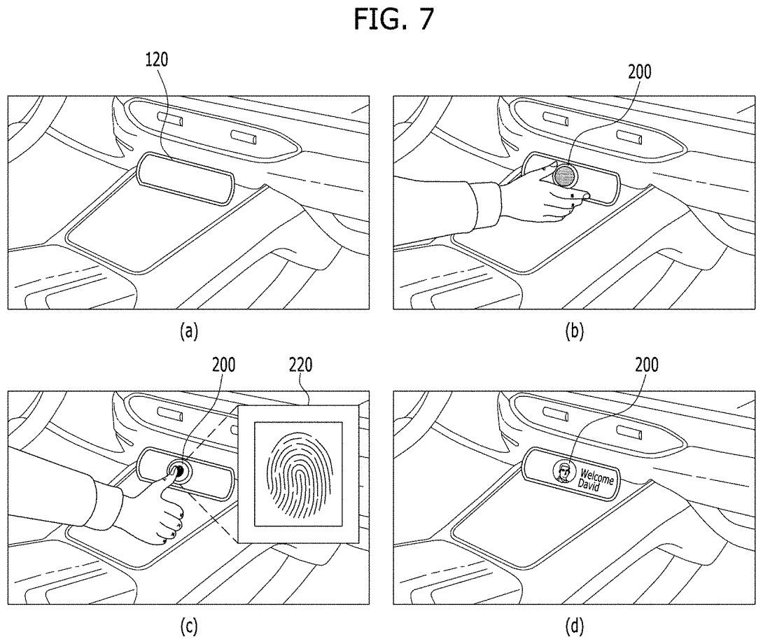

The welcome and start functions using the smart key are described with reference to FIG. 7. FIG. 7 is a view showing an example of performing welcome and start functions using a smart key according to an embodiment of the present disclosure.

Referring to (a) of FIG. 7, the display 120 of the integrated manipulation unit 100 is disposed at the lower end of the center fascia and the attachment area may be disposed at the center of the display 120. Until the vehicle starts, the display 120 is turned off and only the smart detector 130 is in an on state. At this time, the smart key detector 130 may be turned on when the smart key controller SMK detects the smart key 200 inside the vehicle.

In this state, when the driver rides in the vehicle and the smart key 200 is attached to the center of the display 120 as shown in (b) of FIG. 7, start text may be displayed on the display of the smart key 200. At this time, when the driver pushes the smart key 200, the vehicle may start.

At this time, when the display of the smart key 200 is provided with a fingerprint recognition sensor, as shown in (c) of FIG. 7, the vehicle may start through fingerprint recognition. In addition, the recognized fingerprint shape may be displayed on the display 220 of the smart key 200. The displayed fingerprint shape may be different from an actually recognized fingerprint shape.

Unlike the embodiment shown in (b) of FIG. 7, when the driver rides in the vehicle and then the smart key 200 is attached to the attachment area, as shown in (d) of FIG. 7, the image of the driver may be output on the display of the smart key 200 and a welcome message may be output on the display 120 of the integrated manipulation unit 100. After the welcome message is output, the state may transition to the state shown in (b) of FIG. 7 again.

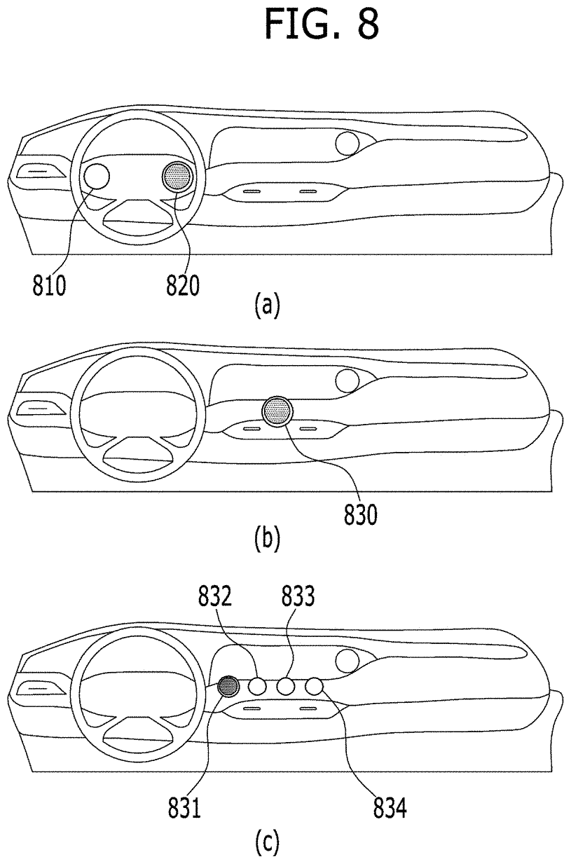

In the above-described embodiments, the attachment area is disposed on or near the display 120 of the integrated manipulation unit 100 located at the lower end of the center fascia. However, this is an example and the attachment area may be variously changed. This is described with reference to FIG. 8. FIG. 8 is a view showing attachment areas according to an embodiment of the present disclosure.

Referring to (a) of FIG. 8, the attachment area may be a point 810 or 820 of a steering wheel. Alternatively, an attachment area 830 may be disposed at the center of the center fascia as shown in (b) of FIG. 8.

In some embodiments, as shown in (c) of FIG. 8, a plurality of attachment areas 831, 832, 833 and 834 may be provided at the center of the center fascia. In this case, a plurality of smart keys 200 may be simultaneously attached to configure portions of the manipulation system and different target control functions may be applied to the attachment positions. For example, when the smart key 200 is attached to a leftmost attachment area 821, air conditioning control may be immediately performed through the dial 210. When the smart key 200 is attached to a rightmost attachment area 834, multimedia output volume control may be immediately performed through the dial 210. The functions mentioned above are merely examples and various changes may be made without being limited thereto.

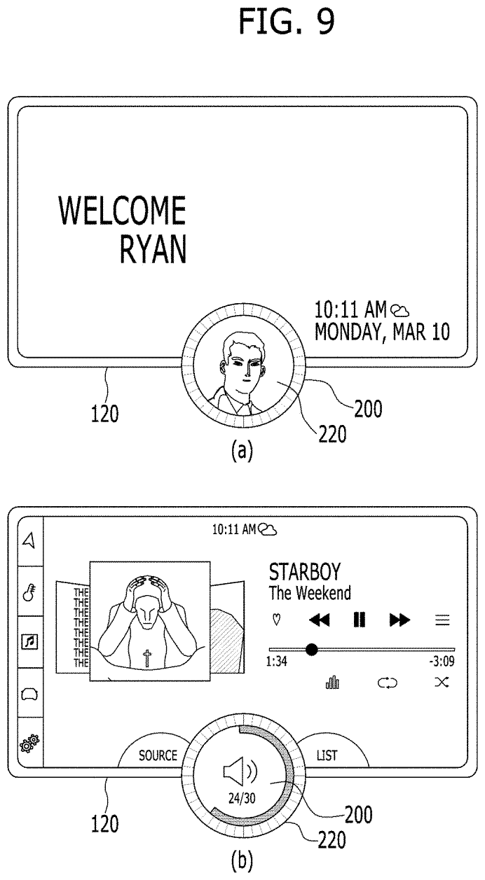

A user interface provided when a smart key is attached is described with reference to FIG. 9. FIG. 9 is a view showing the form of a user interface configured along with a display of an integrated controller when a smart key according to an embodiment of the present disclosure is attached to an attachment area of a vehicle. In (a) and (b) of FIG. 9, it is assumed that the attachment area is disposed in the lower central portion of the display 120 of the integrated manipulation unit 100.

Referring to (a) of FIG. 9, when the smart key 200 is attached for the first time after the driver enters the vehicle, the image of the driver may be output on the display 220 of the smart key 200. Additional information, such as time and date, may be displayed on the display 120 of the integrated manipulation unit 100 along with the welcome message.

In addition, referring to (b) of FIG. 9, when a multimedia playback function is selected and a media player is output on the display 120 of the integrated manipulation unit 100, current volume information may be displayed on the display 220 of the smart key 200. In this state, when the dial 210 is operated, the volume value may be changed according to a degree and direction of rotation.

In addition to the above-described functions, various target control functions shown in Table 1 below may be performed when the smart key 200 according to the embodiment is attached to the vehicle.

TABLE 1

| Menu item | Target control function |
|---|---|
| Profile loading | Loading of profile through user fingerprint |
| | recognition of display |
| Home | Menu movement/menu selection |
| Media | Volume/music change/source change |
| Navigation | Zoom in & out/go to preferred destination |
| Vehicle | Drive mode setting/ADAS integrated setting |
| Air conditioning | Air volume/temperature/mode setting |
| Settings | Menu selection/list movement/detailed |
| | increase/decrease setting |

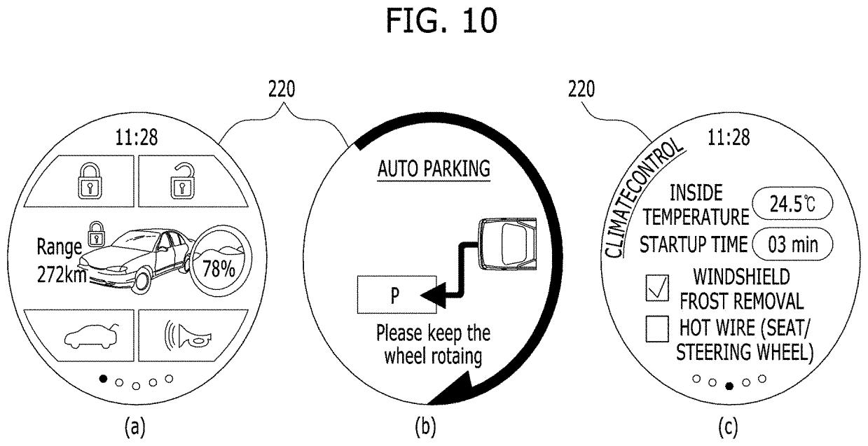

The smart key 200 according to the embodiments of the present disclosure may provide various functions using the display 220 even outside the vehicle. This is described with reference to FIG. 10. FIG. 10 is a view showing an example of the function of a smart key according to an embodiment of the present disclosure.

Referring to (a) of FIG. 10, a touch button corresponding to a vehicle door lock/unlock/trunk open/horn function may be displayed outside the vehicle similarly to a general smart key. Vehicle state information may also be displayed.

In addition, an automatic parking mode is activated through predetermined menu item manipulation, automatic parking may be performed through rotation of wheels as shown in (b) of FIG. 10.

In addition, as shown in (c) of FIG. 10, when a remote start function is performed, a user interface capable of selecting an air conditioning control value along with remote start may be output.

In addition to the above-described functions, the smart key 200 according to the embodiment may perform various functions shown in Table 2 below outside the vehicle.

TABLE 2

| Classification | Menu item | Main functions |
|---|---|---|
| Smart key | Door | Lock/unlock/trunk |
| function | Automatic | Remote start, unparking/parking |
| | parking | |
| Telematics | Vehicle state | Door open/air conditioning, and |
| | checking | the like. |
| | Vehicle | Air conditioning/hot |
| | remote | wire/window operation |
| | control | |
| Other content | Bio | Checking of user through |
| | recognition | display fingerprint recognition |
| | Vehicle | Use of surround view monitor |
| | monitoring | (SVM) |
| | | Monitoring of situation around |
| | | vehicle |
| | Interfacing | Sharing of |
| | with | Schedule/weather/destination |
| | smartphone | |
| | Loss | Checking of position of key |
| | notification | |

Although the smart key 200 is linked to the display 120 of the integrated manipulation unit 100 to output a user interface, the present disclosure is not limited thereto and the smart key may be attached to the periphery of a touch panel without a display function to configure the manipulation system of the vehicle along with the touch panel.

The vehicle control method using the smart key according to the above-described embodiments of the present disclosure may have the following effects.

First, the number of switches may be reduced, thereby increasing the degree of freedom in design of the smart key and the manipulation system of the vehicle and enhancing intuitive usability. For example, a smart key physical key button may be simplified. In another example, a center fascia and floor console switches may be integrated through function combination.

In addition, since the smart key is attached/detached using magnetic force, usability is enhanced. In other words, since the magnetic force of the permanent magnet or electromagnet is used instead of a mechanical structure for fixing the smart key to the attachment area, it is possible to conveniently attach the smart key to the attachment area, only by disposing the smart key to be close to the attachment area.

In addition, when a wireless charging function is included in the smart key, since wireless charging is automatically performed by attaching the smart key, a separate charging slot need not be prepared or provided, or a battery need not be replaced.

In addition, it is not necessary for the driver to have to look at a degree of manipulation. The driver can keep his/her eyes looking forward while driving the vehicle through a feeling of manipulation of a physical dial.

The vehicle control apparatus according to at least one embodiment of the present disclosure having the above-described configuration can provide a more convenient user interface in connection with the smart key provided with the display.

In addition, the present disclosure provides a function, which varies according to the position of the smart key provided with the display inside the vehicle. In particular, the smart key configures a portion of the manipulation system inside the vehicle, thereby controlling various functions according to the state of the vehicle.

The effects of the present disclosure are not limited to the above-described effects. Other effects, which are not described herein may be derived by those of ordinary skill in the art from the above description of the embodiments of the present disclosure.

The disclosure can also be embodied as computer readable code on a computer readable recording medium. The computer readable recording medium is any data storage device that can store data which can thereafter be read by a computer system. Examples of the computer readable recording medium include read-only memory (ROM), random-access memory (RAM), CD-ROMs, magnetic tapes, floppy disks, optical data storage devices, and the like.

The above embodiments are therefore to be construed in all aspects as illustrative and not restrictive. The scope of the disclosure should be determined by the appended claims and their legal equivalents. All changes coming within the meaning and equivalency range of the appended claims are intended to be embraced therein.

What is claimed is:

1. A vehicle control method using a smart key, the vehicle control method comprising:
an integrated manipulation unit detecting attachment of the smart key through a smart key detector disposed in a predetermined attachment area inside a vehicle;
the integrated manipulation unit transmitting information on a target control function corresponding to a vehicle state to the smart key;
outputting a first user interface corresponding to the information on the target control function on a first display of the smart key;
transmitting information on a result of manipulation from the smart key to the integrated manipulation unit when an operating portion provided in the smart key is operated; and
the integrated manipulation unit controlling the target control function based on the information on the result.

2. The vehicle control method according to claim 1,
wherein the smart key has a cylindrical appearance, and
wherein the first display is disposed at a center of the smart key in a circular shape.

3. The vehicle control method according to claim 2, wherein the operating portion includes a dial having a ring shape to surround the first display.

4. The vehicle control method according to claim 1, wherein the integrated manipulation unit further includes a second display disposed around the smart key detector.

5. The vehicle control method according to claim 4, further comprising outputting a second user interface corresponding to the information on the target control function through the second display,
wherein the first user interface and the second user interface integrally configure a user interface corresponding to the target control function.

6. The vehicle control method according to claim 1, further comprising:
transmitting authentication information stored in the smart key to the integrated manipulation unit when the smart key is attached to the attachment area; and
the integrated manipulation unit loading personalization function settings based on the authentication information.

7. The vehicle control method according to claim 1, wherein the target control function includes a start button function or a welcome function before the vehicle starts.

8. The vehicle control method according to claim 1, wherein each of the smart key and the attachment area includes two or more magnetic-force-based attachment portions at positions corresponding to each other and in shapes corresponding to each other.

9. The vehicle control method according to claim 1,
wherein the attachment area includes a plurality of different attachment areas, and
wherein the target control function differs between the plurality of attachment areas.

10. A non-statutory computer readable recording medium having recorded thereon a program for executing the vehicle control method using the smart key according to claim 1.

11. A vehicle manipulation system comprising:
a smart key including an operating portion and a first display; and
an integrated manipulation unit configured to transmit information on a target control function corresponding to a vehicle state to the smart key when the integrated manipulation unit detects attachment of the smart key through a smart key detector disposed in a predetermined attachment area inside a vehicle,
wherein the smart key outputs a first user interface corresponding to the information on the target control function on the first display and transmits information on a result of manipulation to the integrated manipulation unit when the operating portion is operated, and
wherein the integrated manipulation unit controls the target control function based on the information on the result.

12. The vehicle manipulation system according to claim 11, wherein the smart key has a cylindrical appearance, and
wherein the first display is disposed at a center of the smart key in a circular shape.

13. The vehicle manipulation system according to claim 12, wherein the operating portion includes a dial having a ring shape to surround the first display.

14. The vehicle manipulation system according to claim 11, wherein the integrated manipulation unit further includes a second display disposed around the smart key detector.

15. The vehicle manipulation system according to claim 14,
wherein the integrated manipulation unit performs control to output a second user interface corresponding to the information on the target control function on the second display, and
wherein the first user interface and the second user interface integrally configure a user interface corresponding to the target control function.

16. The vehicle manipulation system according to claim 11,
wherein the smart key transmits stored authentication information to the integrated manipulation unit when the smart key is attached to the attachment area, and
wherein the integrated manipulation unit loads personalization function settings based on the authentication information.

17. The vehicle manipulation system according to claim 11, wherein the target control function includes a start button function or a welcome function before the vehicle starts.

18. The vehicle manipulation system according to claim 11, wherein each of the smart key and the attachment area includes two or more magnetic-force-based attachment portions at positions corresponding to each other and in shapes corresponding to each other.

19. The vehicle manipulation system according to claim 11,
wherein the attachment area includes a plurality of different attachment areas, and
wherein the target control function differs between the plurality of attachment areas.

20. A smart key comprising:
an operating portion;
a wireless communication unit;
a display; and
a controller configured to perform control to output a user interface corresponding to information on a target control function through the display when an integrated manipulation unit of a vehicle receives the information on the target control function corresponding to a vehicle state through the wireless communication unit as the smart key is attached to a predetermined attachment area inside the vehicle and to control the wireless communication unit to transmit information on a result of manipulation to the integrated manipulation unit such that the integrated manipulation unit controls the target control function according to the manipulation when the manipulation portion is operated.
